(19) United States
(12) Patent Application Publication
(10) Pub. No.: US 2013/0148519 A1
(43) Pub. Date: Jun. 13, 2013

(54) SYSTEM AND METHOD FOR TESTING WIRELESS NETWORK DEVICE

(71) Applicants: Yu-Chen Yu, New Taipei City (TW); Yung-Hung Lan, Taipei City (TW); Ching-Feng Hsieh, Taipei (TW)

(72) Inventors: Yu-Chen Yu, New Taipei City (TW); Yung-Hung Lan, Taipei City (TW); Ching-Feng Hsieh, Taipei (TW)

(73) Assignees: ASKEY COMPUTER CORPORATION; ASKEY TECHNOLOGY (JIANGSU) LTD., Wuijiang Economic-Technological (CN)

(21) Appl. No.: 13/434,470

(22) Filed: Mar. 29, 2012

(30) Foreign Application Priority Data
Dec. 13, 2011 (TW) 100145906

(51) Int. Cl. H04W 24/02

(52) U.S. Cl. 370/252

(57) ABSTRACT

A system for testing a wireless network device determines a limit of the sensitivity of the wireless network device under test by adjusting the power of testing apparatuses. A set module sets test parameters. The testing apparatuses transmit a predetermined amount of testing packets based on the test parameters set by the set module. An amount of testing packets received by the wireless network device under test is recorded. A control module compares the amount of testing packets received by the wireless network device under test with a predetermined value to determine whether the limit of the sensitivity of the wireless network device under test complies with a wireless network standard, and the power of the testing apparatuses is adjusted to obtain the limit of the sensitivity of the wireless network device under test. In addition, the present invention discloses a method for testing a wireless network device.

### FIELD OF THE INVENTION

The present invention relates to techniques for testing a wireless network device, and, more particularly, to a system and method for testing the sensitivity of a wireless network device with integrated testing apparatuses.

### BACKGROUND OF THE INVENTION

Wireless Local Area Network (WLAN) connection involves using a wireless network card of a network terminal in combination with an Access Point (AP) for wireless network connection. If the AP is further connected with an external line, such as Asymmetric Digital Subscriber Line (ADSL), optical fiber etc., various wireless network resources can be used. Since having high transmission speed and relatively low deployment cost, WLAN has been widely used as a technique for network connection.

Currently, before put on the market, wireless network devices have to comply with certain wireless network standards to ensure the compatibility and stability of the devices produced by various manufacturers. As such, wireless network devices will undergo a series of tests designed by the manufacturers so as to ensure the devices will conform to relevant standards. In current testing techniques for wireless network devices, the devices are tested mainly in accordance with RF specifications using radio frequency testing apparatuses such as a spectrum analyzer, a vector signal analyzer, a vector signal generator, an RF power meter, and a power splitter in various different testing environments. However, the numerous testing apparatuses and measurement parameters for the wireless network device have to be repeatedly and manually set up, RF tests and test data also have to be performed and recorded manually, and the test data are then analyzed before a test report can be obtained. This process of testing is time consuming and error-prone.

There is thus a need for a technique for testing a wireless network device by integrating testing apparatuses to perform test procedures, which overcomes the existing problems in the prior art.

### SUMMARY OF THE INVENTION

In light of the foregoing drawbacks, an objective of the present invention is to provide a system and method for testing a wireless network device to see whether the sensitivity of the wireless network devices complies with wireless network standards and to obtain the limit of the sensitivity.

Another objective of the present invention is to provide a system and method for testing a wireless network device that saves on human labor and increases utilization rate of testing apparatuses.

Yet another objective of the present invention is to provide a system and method for testing a wireless network device that simplifies test procedures by integrating testing apparatuses.

In accordance with the above and other objectives, the present invention provides a system for testing a wireless network device, which may include: a set module for setting test parameters, the test parameters including at least wireless radio frequency (RF) parameters of the wireless network device under test and a predetermined amount of testing packets to be transmitted by one or more testing apparatuses; a test module for causing the testing apparatuses to transmit the predetermined amount of testing packets based on the test parameters set by the set module, and recording an amount of testing packets received by the wireless network device under test; and a control module for comparing the amount of testing packets received by the wireless network device under test with a predetermined value to determine whether sensitivity of the wireless network device under test complies with a wireless network standard, and adjusting power of the testing apparatuses to obtain a limit of the sensitivity.

In an embodiment, if the amount of testing packets received by the wireless network device under test is determined to be greater than the predetermined value, the control module reduces the power of the testing apparatuses, and if otherwise, the control module increases the power of the testing apparatuses.

In an embodiment, after obtaining the limit of the sensitivity, the control module further determines the correctness of the limit of the sensitivity with confirmation tests.

The present invention further provides a method for testing a wireless network device, which includes the following steps of: setting wireless radio frequency test parameters of the wireless network device under test; transmitting, by one or more testing apparatuses, a predetermined amount of testing packets, and receiving, by the wireless network device under test, the testing packets transmitted from the testing apparatuses; recording an amount of testing packets received by the wireless network device under test, and comparing the amount of testing packets received by the wireless network device under test with a predetermined value, wherein if the amount of testing packets received by the wireless network device under test is greater than the predetermined value, the power of the testing apparatuses is reduced, and the testing apparatuses retransmit the testing packets until the amount of testing packets received by the wireless network device under test is less than the predetermined value; and obtaining the power of the testing apparatuses at a previous instance before an instance in which the amount of the testing packets received is reduced to first become less than the predetermined value.

In an embodiment, if the amount of testing packets received by the wireless network device under test is less than the predetermined value, the power of the testing apparatuses is increased, and the testing apparatuses retransmit the testing packets until the amount of testing packets received by the wireless network device under test is greater than the predetermined value.

The method for testing a wireless network device may further include performing a plurality of confirmation tests on the power of the testing apparatuses obtained at the previous instance.

In an embodiment, if error is generated as a result of the confirmation tests, the power of the testing apparatuses at a further previous instance is selected for testing until there is no error result.

Compared to the prior art, the present invention provides the system and method for testing a wireless network device, which determine whether the sensitivity of the wireless network device under test complies with wireless network standards by detecting conditions of the wireless network device under test when receiving testing packets, and adjusts the power of the testing apparatuses accordingly to obtain a limit of the sensitivity of the wireless network device under test. In addition, the testing procedures require only the integration of testing apparatuses, which overcomes the shortcomings of the prior art by reducing time, cost and errors. Therefore, the efficiency in testing the wireless network device is raised, and not only the accuracy of the tests is increased and errors are reduced, the testing procedures are also simplified.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram illustrating a system for testing a wireless network device according to an embodiment of the present invention;

FIG. 2 is a flowchart illustrating a method for testing a wireless network device according to an embodiment of the present invention; and

FIGS. 3A and 3B are flowcharts illustrating specific implementations of the method for testing a wireless network device according to an embodiment of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

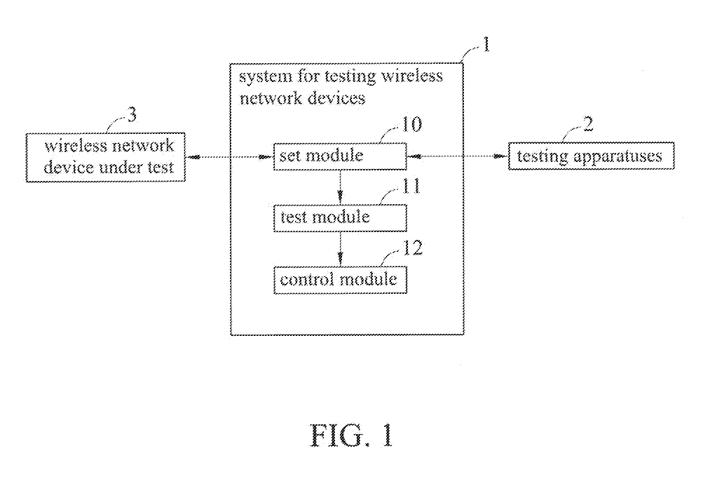

FIG. 1 is a block diagram illustrating a system 1 for testing a wireless network device according to an embodiment of the present invention. The system 1 includes a set module 10, a test module 11, and a control module 12. The system 1 integrates testing apparatuses 2 so as to measure the sensitivity of a wireless network device under test 3. In an embodiment, the system 1 is applicable to wireless network devices that adopt wireless network standards such as APs.

The set module 10 is used for setting up test parameters. The test parameters include test parameters for the wireless network device under test 3 and the testing apparatuses 2. More specifically, the test parameters include at least wireless RF parameters of the wireless network device under test 3 and a predetermined amount of testing packets sent by the testing apparatuses 2. In addition, the set module 10 also carries information related to wireless network standards to be tested (such as IEEE 802.11 a/b/g/n). More specifically, the RF parameters set by the set module 10 include at least one selected from the group consisting of the size, the frequency and the speed of the sent testing packets, as well as the receiving conditions of the wireless network device under test 3, and the like.

In an embodiment, the system 1 can provide a graphic interface that allows users to easily set relevant test parameters.

The test module 11 enables the testing apparatuses 2 to send a predetermined amount of testing packets with a predetermined power based on the test parameters set by the set module 10, and record the amount of testing packets received by the wireless network device under test 3. The system 1 determines whether the sensitivity of the wireless network device under test 3 complies with the wireless network standards (i.e., whether the maximum power for which a receiver of the wireless network device under test 3 can normally receive signals complies with the wireless network standards) and the limit of the sensitivity (i.e., the minimum power for which the receiver of the wireless network device under test 3 can normally receive signals). Thus, the test module 11 controls the transmission and reception of testing packets at the testing apparatuses 2 and the wireless network device under test 3, and measures the amount of testing packets received by the wireless network device under test 3 from the testing apparatuses 2, so that the best receiving conditions of the wireless network device under test 3 can be analyzed.

The control module 12 is used for comparing the amount of testing packets received by the wireless network device under test 3 with a predetermined value to determine whether the sensitivity of the wireless network device under test 3 complies with the wireless network standards, and the power of the testing apparatuses 2 is adjusted to obtain the limit of the sensitivity. That is, the control module 12 compares the amount of testing packets received by the wireless network device under test 3 with a predetermined value to obtain the sensitivity of the wireless network device under test 3, thereby determining whether the wireless network device under test 3 complies with the wireless network standards, and deciding whether to adjust the power of the testing apparatuses 2 to obtain the limit of the sensitivity. In other words, based on the amount of the testing packets received, it is determined whether the current environment is the best condition, and the environment contents are adjusted to obtain the limit of the sensitivity.

In actual implementations, if the amount of testing packets received by the wireless network device under test 3 is greater than the predetermined value, the control module 12 reduces the power of the testing apparatuses 2; else, if the amount of testing packets received by the wireless network device under test 3 is less than the predetermined value, the control module 12 increases the power of the testing apparatuses 2. In other words, when the amount of testing packets received is large, e.g., exceeding a certain threshold, the current environment is not indicated to be the limit, so the power of the testing apparatuses 2 is reduced to try to find out a lower power for which the wireless network device under test 3 can still receive a satisfying amount (i.e., the predetermine value) of the testing packets. On the contrary, when the amount of testing packets received is small, the power of the testing apparatuses 2 is increased to find the best environment. At this time, after the power of the testing apparatuses 2 is adjusted by the control module 12, the testing apparatuses 2 is caused to resend testing packets with the adjusted power.

In an embodiment, the system 1 further includes a conformation testing procedure, which confirms the correctness of the limit of the sensitivity after it is obtained by the control module 12. The confirmation testing procedure can be iterative with a plurality of tests, so that the chance that the test result is correct is higher. For example, tests are repeatedly performed for three times. If there is no error, it indicates the result chosen is correct. If one of the tests fails, the power of the testing apparatuses 2 previously chosen is used as the test result.

From the above, it can be seen that by adjusting the power of the testing apparatuses 2, while recording the amount of testing packets received, whether the sensitivity of the wireless network device under test 3 complies with the wireless network standards is determined, and the limit of the sensitivity of the wireless network device under test 3 is further determined. Thus, with the system 1, whether the sensitivity of the wireless network device under test 3 complies with the wireless network standards can be determined, and the limit of the sensitivity of the wireless network device under test 3 can also be determined.

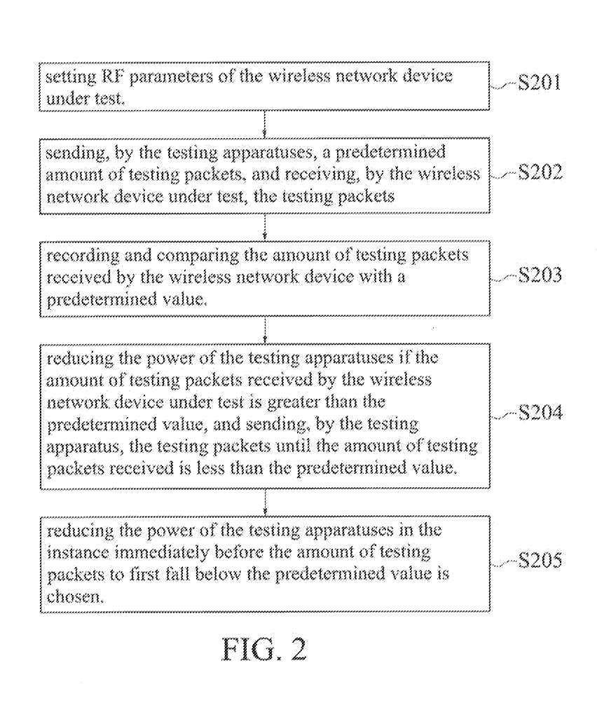

Next, a method for testing a wireless network device is discussed with respect to FIG. 2 in conjunction with the system 1 shown in FIG. 1.

In step S201, RF parameters of the wireless network device under test are set. Simply put, relevant parameters of the wireless network device under test are set before the tests, which may further include parameter setting for packets transmitted between the wireless network device under test and the testing apparatuses, wherein, the RF parameters include at least one selected from the group consisting of the size, the frequency and the speed of the testing packets sent, and the receiving condition of the wireless network device under test. Then, proceed to step S202.

In step S202, a predetermined amount of testing packets is sent by the testing apparatuses and the testing packets are received by the wireless network device under test. In step S202, testing phase is entered. At this time, the testing apparatuses transmit a predetermined amount of testing packets, and the wireless network device under test receives the testing packets. Then, proceed to step S203.

In step S203, the amount of testing packets received by the wireless network device under test is recorded and compared with a predetermined value. In order to know the sensitivity of the wireless network device under test, the amount of testing packets received by the wireless network device under test is recorded. That is, based on the predetermined amount of testing packets sent by the testing apparatus, whether the wireless network device under test is in a good receiving condition can be deduced. The predetermined value herein can be a predetermined threshold value. For example, if a packet loss rate of less than 10% is desired, when the predetermined amount is 1000, the predetermined value will be 900. Then, proceed to step S204.

In step S204, if the amount of testing packets received by the wireless network device under test is greater than the predetermined value, the power of the testing apparatuses is reduced and the testing packets are resent by the testing apparatus. Step S204 is repeated until the amount of testing packets received is less than the predetermined value. In an embodiment, the maximum power of the testing apparatuses is initially set for sending the testing packets. At the maximum power, the amount of testing packets received by the wireless network device under test should be greater than the predetermined value, and thus the power of the testing apparatuses is reduced, which may result in fewer testing packets received by the wireless network device under test. Step S204 is repeated until the amount of testing packets received is less than the predetermined value. Then, proceed to step S205.

In step S205, the power of the testing apparatuses in the instance immediately before the amount of testing packets is reduced to first fall below the predetermined value in step S204 is chosen. In other words, after testing in step S204, the power of the testing apparatuses in the instance immediately before the amount of testing packets is reduced to first fall below the predetermined value is obtained (i.e., this is the minimum power for which the amount of testing packets received is greater than the predetermined value), thereby determining the best operating condition of the wireless network device under test, that is, the limit of the sensitivity of the wireless network device under test.

It should be noted that in other embodiments, the testing apparatuses in step S204 do not initially transmit testing packets with the maximum power. That is, when the testing apparatuses start to transmit with a lower power, the amount of testing packets received may be less than the predetermined value, and the power of the testing apparatuses 2 is increased accordingly. In other words, based on the comparison of the amount of testing packets received with the predetermined value, the power of the testing apparatuses is increased or decreased accordingly.

In an embodiment, before step S201, the number of testing apparatuses can be provided in accordance with the number of antennas arranged in the wireless network device under test. In other words, this step is a preparing step for the transmission between the wireless network device under test and the testing apparatus, that is, the number of testing apparatuses is provided based on the number of antennas owned by the wireless network device under test.

In order to ensure the correctness of the test, after step S205, confirmation tests are performed a plurality of times on the power of the testing apparatuses obtained in the step S205. In the plurality of confirmation tests, when an error result is produced, the power of the testing apparatuses in the instance before the current one (chosen in step S205) is selected (that is, the second smallest power for which the amount of testing packets received is greater than the predetermined value) is chosen for testing until no error is obtained. After the limit of the sensitivity is found through steps S204 and S205, if any one of the confirmation tests fails, the power of the testing apparatuses of the instance before the current one is chosen for confirmation testing. The process stops when the selected power results in no error in the plurality of confirmation tests.

In another embodiment, the data and test results in the whole testing process can be recorded in a test log, and can be preferably converted into a specific file format such as the excel format, for producing a test report.

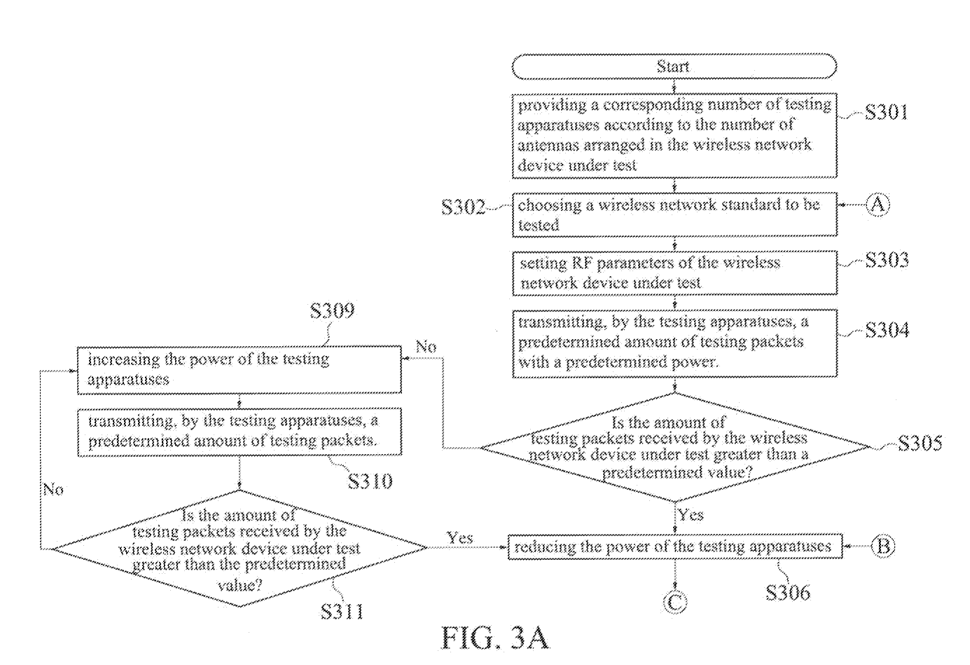

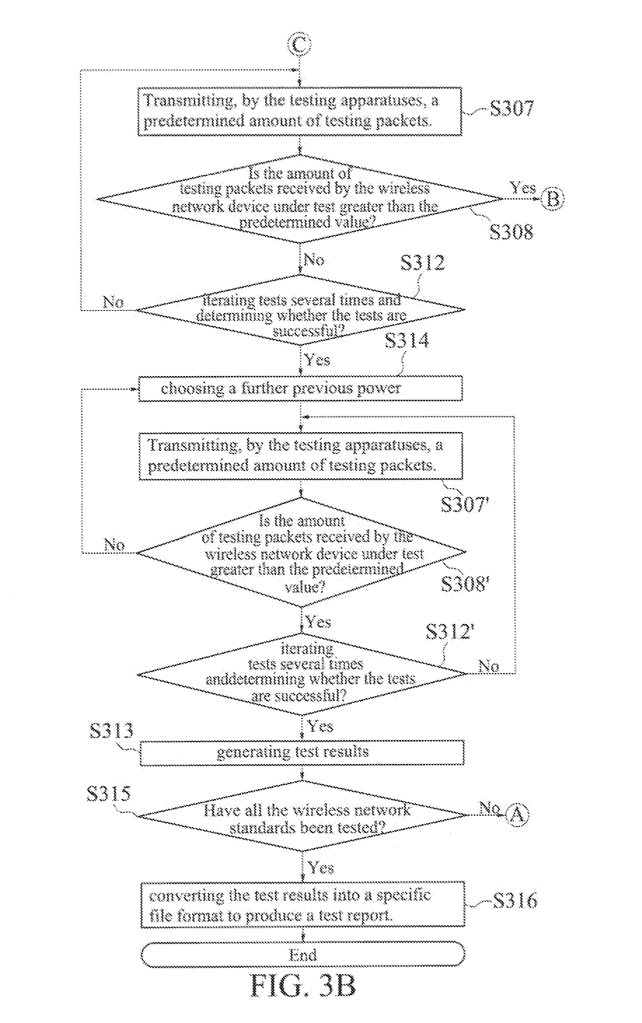

In order to facilitate the understanding of the testing process for the limit of the sensitivity, operations that may be performed in the present invention are described in conjunction with contents shown in FIGS. 1 and 2. FIGS. 3A and 3B are flowcharts illustrating specific implementations of the method for testing a wireless network device according to an embodiment of the present invention.

As shown, first, step S301 is performed, in which a corresponding number of testing apparatuses 2 is provided according to the number of antennas arranged in the wireless network device under test 3. For example, the wireless network device under test 3 is an AP with two antennas, and two testing apparatuses 2 can be provided by the user, wherein the testing apparatuses 2 may integrate testing apparatuses such as a vector signal analyzer, a vector signal generator or an RF power meter. Then, proceed to step S302.

In step S302, a wireless network standard to be tested is chosen. In an embodiment, four wireless network standards are to be tested, such as IEEE 802.11 a/b/g/n, for testing different wireless network standards. Then, proceed to step S303.

In step S303, RF parameters of the wireless network device under test 3 are set, that is, the receiving condition of the wireless network device under test 3 is set, which includes parameter for packet transmission between the wireless network device under test 3 and the testing apparatuses 2. Then, proceed to step S304.

In step S304, the testing apparatuses 2 transmit a predetermined amount of testing packets with a predetermined power. In order to obtain the reception sensitivity of the wireless network device under test 3, the amount of testing packets received by the wireless network device under test 3 is recorded and analyzed. Thus, the amount of testing packets transmitted is set here. Then, proceed to step S305.

In step S305, it is determined whether the amount of testing packets received by the wireless network device under test 3 is greater than a predetermined value. In Step S305, the amount of testing packets received by the wireless network device under test 3 is compared with a predetermined value. For example, if a packet loss rate of less than 10% is desired, when 1000 testing packets are transmitted, the predetermined value will be 900 testing packets. Then, based on the comparison result, proceed to steps S306-S308 or steps S309-S311. It should be noted that, based on the comparison result in step S305, whether the sensitivity of the wireless network device under test complies with the chosen wireless network standard can be determined

In steps S309-S311, which are the conditions in which the amount of testing packets received by the wireless network device under test 3 is less than the predetermined value, this indicates the power of the testing apparatuses 2 is too low, and, as a result, the amount of testing packets received by the wireless network device under test 3 cannot reach the predetermined value. Thus, in step S309, the power of the testing apparatuses 2 is increased.

In step S310, the predetermined amount of testing packets is sent by the testing apparatuses 2 again. Thereafter, in step S311, it is determined whether the amount of testing packets received by the wireless network device under test 3 is greater than the predetermined value; if not, the power of the testing apparatuses 2 is still too low, so return to step S309 to further increase the power of the testing apparatuses 2. If the amount of testing packets received is greater than the predetermined value in step S311, proceed to step S306.

In steps S306-S308, which are the conditions in which the amount of testing packets received by the wireless network device under test 3 is greater than the predetermined value, this indicates the power of the testing apparatuses 2 is too high, and, as a result, the amount of testing packets received by the wireless network device under test 3 exceeds the predetermined value. Thus, in step S306, the power of the testing apparatuses 2 is reduced.

In step S307, the predetermined amount of testing packets is sent by the testing apparatuses 2 again. Thereafter, in step S308, it is determined whether the amount of testing packets received by the wireless network device under test 3 is greater than the predetermined value; if so, the power of the testing apparatuses 2 is still too high, so return to step S306 to further decrease the power of the testing apparatuses 2. If the amount of testing packets received is less than the predetermined value in step S308, proceed to step S312.

It should be noted that the testing method goes to steps S306-S308 or steps S309-S311 based on the result determined in step S305. In other words, if the initial power of the testing apparatuses 2 is at the maximum, then the method directly enters into steps S306-S308 to reduce the power of the testing apparatuses 2. On the contrary, if the testing apparatuses 2 start with a lower power, then the method may enter into steps S309-S311 to increase the power of the testing apparatuses 2. Once the amount of received testing packets is greater than the predetermined value, the method then diverts to steps S306-S308 for testing the limit.

In step S312, tests are iterated several times to determine whether the tests are successful. Step S312 is performed after the amount of received testing packets is determined to be less than the predetermined value in step S308. Tests are performed on the last power obtained in step S308 to ensure that the amount of received testing packets is not greater than the predetermined value in all the tests. If the determination result in step S312 is negative, indicating one or more failures exist in the plurality of tests, then return to steps S307, S308 and S312 to resend testing packets and determine again whether the tests are successful. If so, proceed to step S314.

In step S314, the power in the instance before the last power selected in step S308 is chosen (this is the minimum power for which the amount of the testing packets is greater than the predetermined value), and steps S307′, S308′ and S312′ are performed to carry out a plurality of tests on this power to confirm whether this power is the optimum. More specifically, in step S307′, the predetermined amount of testing packets is sent by the testing apparatuses 2 again. Thereafter, in step S308′, it is determined whether the amount of testing packets received by the wireless network device under test 3 is greater than the predetermined value; if not, this means that the current limit is not the most stable one, so return to step S314 to choose a further previous power.

If in step S308′, it is determined the amount of testing packets received by the wireless network device under test 3 is greater than the predetermined value, then proceed to step S312′ to perform iterative tests and see whether the tests are all passed. If not, return to step S307′ to resend testing packets for testing. If so, this means a correct sensitivity limit is selected. Then, proceed to step S313.

In step S313, the test data generated during the test process is recorded to produce test results. In an embodiment, packet transmission and reception conditions and power adjustments are recorded, which include all the successful or failed records. Then, proceed to step S315.

In step S315, it is determined whether all the wireless network standards are tested. If so, proceed to step S316, or return to step S302 for testing of another wireless network standard.

In step S316, the test results are converted into a specific file format such as the excel format, in order to produce a test report.

In summary, the system and method for testing a wireless network device determines whether the sensitivity of the wireless network device under test complies with wireless network standards and the limit of the sensitivity by detecting conditions of the wireless network device under test when receiving testing packets and adjusts the power of the testing apparatuses, and further performs confirmation tests on the obtained the limit of the sensitivity to ensure the correctness of the limit. In addition, through the testing method that integrates the testing apparatuses, the testing procedures are simplified, and efficiency in testing wireless network devices is improved while avoiding human errors during manual testing.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. A system for testing a wireless network device, comprising:
a set module for setting test parameters, the test parameters including at least wireless radio frequency (RF) parameters of a wireless network device under test and a predetermined amount of testing packets to be transmitted by one or more testing apparatuses;
a test module for enabling the testing apparatuses to transmit the predetermined amount of testing packets based on the test parameters set by the set module, and recording an amount of testing packets received by the wireless network device under test; and
a control module for comparing the amount of testing packets received by the wireless network device under test with a predetermined value to determine whether sensitivity of the wireless network device under test complies with a wireless network standard, and adjusting power of the testing apparatuses to obtain a limit of the sensitivity.

2. The system of claim 1, wherein the RF parameters includes at least one of a size, a frequency and a speed of the transmitted testing packets, and reception conditions of the wireless network device under test.

3. The system of claim 1, wherein if the amount of testing packets received by the wireless network device under test is determined to be greater than the predetermined value, the control module reduces the power of the testing apparatuses, or the control module increases the power of the testing apparatuses.

4. The system of claim 1, wherein the control module, after adjusting the power of the testing apparatuses, enables the testing apparatuses to retransmit the predetermined amount of testing packets with the adjusted power.

5. The system of claim 1, wherein the control module, after obtaining the limit of the sensitivity, further determines correctness of the limit of the sensitivity with confirmation tests.

6. A method for testing a wireless network device, comprising the following steps of:
setting wireless radio frequency test parameters of a wireless network device under test;
transmitting, by one or more testing apparatuses, a predetermined amount of testing packets, and receiving, by the wireless network device under test, the testing packets transmitted from the testing apparatuses;
recording an amount of testing packets received by the wireless network device under test, and comparing the amount of testing packets received by the wireless network device under test with a predetermined value;
transmitting, by the one or more testing apparatuses, the predetermined amount of testing packets with reduced power if the amount is greater than the predetermined value, until the amount of testing packets received by the wireless network device under test is less than the predetermined value; and
obtaining the power of the testing apparatuses at a previous instance before an instance in which the amount of the testing packets received is reduced to first become less than the predetermined value.

7. The method of claim 6, wherein the RF parameters includes at least one of a size, a frequency and a speed of the transmitted testing packets, and reception conditions of the wireless network device under test.

8. The method of claim 6, further comprising providing a corresponding number of testing apparatuses based on a number of antennas arranged in the wireless network device under test.

9. The method of claim 6, wherein if the amount of testing packets received by the wireless network device under test is less than the predetermined value, the power of the testing apparatuses is increased, and the testing apparatuses retransmit the testing packets until the amount of testing packets received by the wireless network device under test is greater than the predetermined value.

10. The method of claim 6, further comprising performing a plurality of confirmation tests on the power of the testing apparatuses obtained at the previous instance.

11. The method of claim 10, wherein, in the plurality of confirmation tests, if error is generated as a result, the power of the testing apparatuses at a further previous instance is selected for testing until there is no error result.
